(19) United States
(12) Patent Application Publication
(10) Pub. No.: US 2025/0370985 A1
(43) Pub. Date: Dec. 4, 2025

(54) HYBRID DATABASE ARCHITECTURE FOR CUSTOM SCALE-OUT

(71) Applicant: Microsoft Technology Licensing, LLC, Redmond, WA (US)

(72) Inventors: John Bronn SOCHA-LEIALOHA, Bellevue, WA (US); Marc Victor EL HADDAD, Redmond, WA (US)

(21) Appl. No.: 18/678,058

(22) Filed: May 30, 2024

(51) Int. Cl. G06F 16/23; G06F 16/215; G06F 16/27

(52) U.S. Cl. CPC G06F 16/2358; G06F 16/215; G06F 16/27

(57) ABSTRACT

A method of hybrid database operation includes receiving, at a hybrid database storage system, a write request for a data record; assigning ownership of the data record to a first database; writing a primary copy of the data record to the first database and a shadow copy of the data record to a second database; detecting changes to the primary copy of the data record made in the first database while the first database remains owner of the data record; propagating the changes to the shadow copy of the data record to the second database; transferring ownership of the data record from the first database to the second database in response to determining ownership transfer criteria are satisfied for the data record; and subsequent to transferring the ownership, directing updates to the data record to the second database without updating data in the first database.

### BACKGROUND

When designing a database, a software engineer typically selects a database type and database architecture based, at least in part, on the intended function to be served by the database, the expected quantity of data to be stored in the database, and/or anticipated database workload (e.g., as given, at least in part, by a number and frequency of anticipated database access requests.) However, it is not always possible to predict or reasonably foresee how the database functionality and/or the anticipated database workload is going to transform over the lifetime of a database.

When the quantity of data within a database and/or frequency of incoming database requests begins to exceed the storage and bandwidth capacity reasonably supported by a select database design, errors and latencies may become more common, such as due to deadlock resulting from concurrently-recited access requests. In these scenarios where limitations of the database in use are regularly encountered, it may be desired to scale-up the original database, such as by increasing server nodes and/or by altering the architecture of the database to better support heavy usage demands.

### SUMMARY

According to one implementation, a method of database operation includes receiving, at a hybrid database storage system, a data record directed; assigning ownership of the data record to a first database; writing a primary copy of the data record to the first database and a shadow copy of the data record to a second database. The method further includes detecting changes to the primary copy of the data record made in the first database while the first database remains owner of the data record; propagating the changes to the shadow copy of the data record to the second database; transferring ownership of the data record from the first database to the second database in response to determining ownership transfer criteria are satisfied for the data record; and, subsequent to transferring the ownership, directing updates to the data record to the second database without updating data in the first database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example hybrid database system implemented the disclosed technology.

FIG. 2A illustrates example operations performed to write a new data record to a hybrid database system implementing aspects of the disclosed technology.

FIG. 2B illustrates further example operations of the hybrid database system of FIG. 2A that are performed to update a data record while the first database remains the owner of the data record.

FIG. 2C illustrates additional example operations performed by the hybrid database system of FIG. 2A-2B to initiate an “age-out” process for a data record.

FIG. 2D illustrates example operations performed by the hybrid database system of FIG. 2A-2C to complete the “age-out” process described with respect to FIG. 2C.

FIG. 3 illustrates exemplary aspects of a hybrid database system.

FIG. 4 illustrates example operations for managing data records within a storage system with a hybrid database architecture.

FIG. 5 illustrates an example schematic of a processing device suitable for implementing aspects of the disclosed technology.

### DETAILED DESCRIPTION

In a common scenario of database upgrade, a company spends a few years building a new database system while the old database system remains online. The new database system is fully built and tested before any part of the new system is turned “on” to manage new incoming data access requests. Once testing is completed, data migration begins. During data migration, the old database is turned off for at least a brief time period, referred to as a “black-out-period.” End users are not able to access the data stored within the database during the black-out period. Following termination of the data migration phase, the new database is switched “on.” If any errors occurred while the data was being copied over, this is the point in time when those errors become apparent and create delays that prolong the black-out period.

When data is migrated between databases that have different database schemas, data migration errors frequently occur as a result of errors (bugs) in schema mappings that evade detection during testing. These schema mappings are even more complex (and more likely to cause copying errors) when the two databases are different types-for example, if one database is a centralized single server system and the other database is a decentralized system that includes multiple servers each storing different shards of data. Addressing the aforementioned data copying errors often requires investigations and corrective measures that significantly delay data availability and frustrate end customers. Consequently, it is generally viewed as risky to migrate data between databases with different schemas and/or architectures.

The herein disclosed technology includes a hybrid database system with an architecture that can be built around an existing database to effectively scale-out the existing database to increase storage capacity and workload bandwidth with flexibility, no data migration downtime (“black-out-period”), and low-risk of errors that disrupt customer access.

According to one implementation, the hybrid database system includes first and second databases that operate in parallel for an extended period of time and/or in perpetuity with data migrations and clean-ups being policy-driven based on highly-customizable characteristics of individual data records and/or network characteristics observed in real time. The hybrid database design supports creation of new data records (e.g., initial writes) in a first database (e.g., an old database system) and creation of “shadow copies” in a second database (e.g., a new database system), with the shadow copies being automatically updated in real time, based on change logs generated by the primary database, to include changes matching changes made to corresponding primary copies of the same data residing in the first database. Record-specific policies support selective “aging-out” of the first database, which entails transferring ownership of a data record from the first database (storing the primary copy) to the second database (storing the shadow copy) at some time after the initial creation of the shadow copy. This is, in some implementations, followed by deletion of the primary copy of the data from the first database—e.g., either concurrent with the ownership transfer or at a later point in time, as governed by applicable record-specific policy. These operations collectively facilitate a gradual reduction in the size of the first database in favor of more storage in the second database.

Notably, the two databases in the hybrid database system can be different database types, of different architectures, and/or support different database schemas. The disclosed hybrid database design can provide advantages in a number of scenarios. In one example use case, the hybrid database system is used to gradually migrate data records to a newer (e.g., higher capacity) database without downtime that disrupts data access. In another example use case, the hybrid database system employs record-specific policies to drive selective redundant data storage in side-by-side databases at a lower overall cost than that which would be incurred to similarly operate two databases storing an identical dataset. For example, high priority data records are maintained in both side-by-side databases while lower priority records are written exclusively to one of the two databases, thereby guaranteeing access to the high priority data records in scenarios where one of the two database systems goes down without incurring resource utilization costs associated with duplicative storage of the lower-priority data records.

In still another example use case, the hybrid database system provides low-cost redundancy by allowing selective, policy-driven “creation” of data records in either of the two databases in the hybrid database system, with the data record creation location being selected based on characteristics of the data record and/or the system itself. For example, a record creation policy may indicate that a certain type of high priority data record is to be initially created in a first database unless that database is offline, in which case, the data record is to be created in a second database. This practice ensures that the high priority data record can always be written without delay when either one of the two databases is inaccessible-all at reduced cost as compared to a complete duplicate database system due to the fact that record-specific policies restrict the types of data receiving additional fault protection.

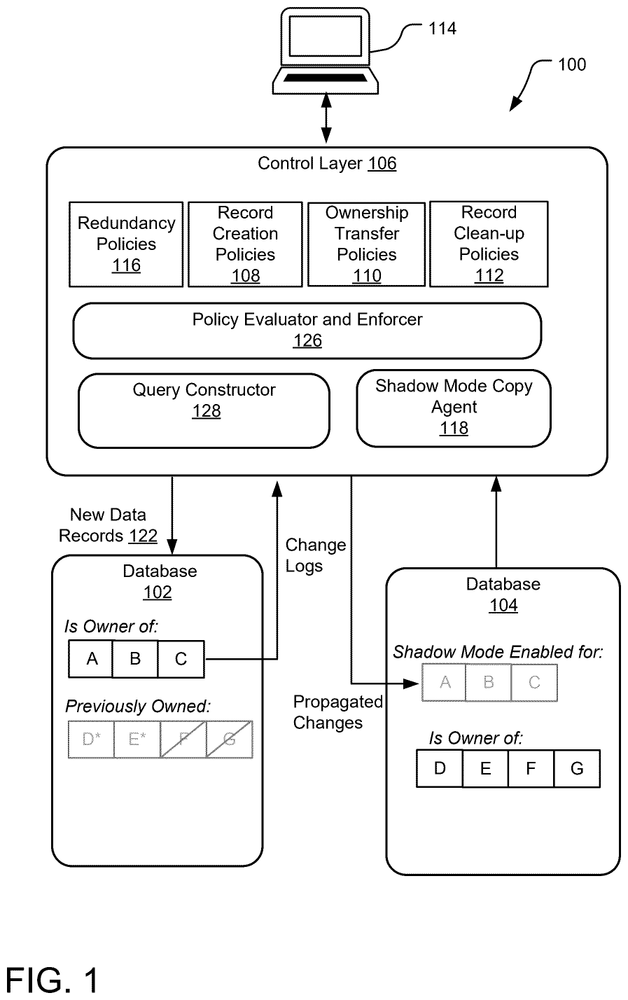

FIG. 1 illustrates an example hybrid database system 100 that includes a first database 102, a second database 104, and a control layer 106 that maintains, evaluates, and enforces record-specific policies that dictate where data records are stored, how the data records are managed (e.g., which database “owns” each data record), and conditions that trigger events such as ownership transfer and clean-up (e.g., deletion or archival of data records).

In one implementation, the first database 102 and the second database 104 are databases of different types. Examples of database types include “centralized” and “decentralized.” In a centralized database system, a single computer in one location performs all computations. A centralized database system may include a single node or multiple sever nodes that communicate with a centralized node to access and update database data. In contrast, distributed database systems utilize data sharding or partitioning to spread data across different server nodes that each individually perform the computations to access, update, and manage their locally-stored data. Distributed database systems advantageously offer improved scalability over centralized systems due to the fact that nodes can be easily added/deleted and/or upgraded/downsized to adjust memory and storage to accommodate changes in workload that occur over time.

Distributed database systems are often viewed as more reliable than centralized database systems due to the fact that there is no singular point of failure (e.g., if one node fails, other nodes can take over its tasks). At the same time, distributed databases tend to be more vulnerable to cyber-attacks since data processing is distributed across many nodes that each presents a possible attack surface. Additionally, distributed databases can be more complex to maintain, frequently requiring the use of specialized tools to manage data spread across multiple repositories. Because centralized and decentralized databases offer different respective advantages, various circumstances may motivate data migration from a centralized database to a decentralized database or vice versa. In one implementation, the hybrid database system 100 is utilized to migrate data from the first database 102 to the second database 104 (potentially, a different type of database) without taking the original system offline for any period of time.

In addition to potentially being of different database types, the first database 102 and the second database 104 may, in some implementations, implement different database architectures. As used herein, the term “database architecture” refers to the structural design and methodology that forms the core of a database management system (DBMS). Types of architectures include: 1—Tier Architecture where the database, database server, and client application accessing the database are all present on the same machine; 2—Tier Architecture where the client application sits on one machine that communicates directly with the database server on another machine; and 3—Tier Architecture where there exists an application server in between a client machine and the database server. In implementations where either the first database 102 or the second database 104 implements a 3—tier architecture, the control layer 106 may execute on the same server or a different server as the application server in between the client machine and the database server.

Regardless of whether the first database 102 and the second database 104 are of the same or different database types or architectures, the first database 102 and the second database 104 may implement different database schemas. A database schema defines how data is organized within a database, including logical constraints such as tables, fields, data types, and the relationships between all stored entities. Migration of data between the first database 102 and the second database 104 can therefore depend upon reference to and interpretation of a mapping that relates a database schema of the first database to a database schema of the second base (e.g., to determine where a value stored in the first database 102 is stored within the second database 104).

The control layer 106 is a logical layer including software components that receive and process incoming database requests in addition to evaluating policies that affect ownership transfer and clean-up of select data records. In one implementation, the control layer 106 is executed on a server that is independent of the database server(s) hosting the first database 102 and the second database 104. For example, the control layer 106 is implemented by an application server that acts as a front door for access to both the first database 102 and the second database 104 by selecting one of the two databases to receive and process each newly-received data access request. In other implementations, the control layer 106 performs the functionality described herein while physically residing on a server node of either the first database 102 or the second database 104.

The control layer 106 is bidirectionally coupled to each of the first database 102 and the second database 104 over a network (e.g., the Internet). In one implementation, a client application on a client machine 114 communicates with the control layer 106 via an application programming interface (API) that exposes a first (e.g., public) database schema that is used to read data from and write data to the first database 102 and the second database 104 in the hybrid database system 100. For example, each incoming request from the client machine 114 includes a uniform resource identifier (URI) that is mapped by the domain name system (DNS) to the server hosting the control layer 106 and additionally includes information identifying a data record that is to be read, written, or updated.

The control layer 106 stores data management policies, including redundancy policies 116, record creation policies 108, ownership transfer policies 110, and record clean-up policies 112, all of which are evaluated and enforced by a policy evaluator and enforcer 126. Some or all of the policies shown and discussed with respect to FIG. 1 are record-specific, meaning the policies apply to individual data records rather than tables, shards, or partitions, or other logical subsets of data. As used herein, the term “data record” refers to a basic data structure that is stored within the hybrid database system 100. Each data record includes a collection of fields, possibly of different data types. For example, an event record is an example of a data record that stores data specific to an individual event with fields that identify information such as when the event occurred, where the event occurred, the type of event, etc. Likewise, a customer record is an example of a data record that stores data specific to an individual customer such as the customer's name, contact information for the customer, configuration data for the customer, subscription data for the customer, etc. By further example, a file record is an example of a data record that stores data specific to an individual file. Notably, a data record can include information that is distributed, within a database, across different tables such as within rows of many tables, whether the cells within each row may or may not be dependent upon other values of the same data record stored in other cells, tables, or rows.

In response to receiving a request to write data of a new data record 122 not yet stored within the hybrid database system 100, the policy evaluator and enforcer 126 evaluates the redundancy policies 116 to determine whether the data record is to be written and managed according to a set of data management operations collectively referred to as “shadow mode.” If shadow mode is enabled for a data record, the data record is subject to “shadow mode operations” that provide for duplicatively storing and/or maintaining the record-for at least some period of time-in both the first database 102 and the second database 104. Consequently, the data record is afforded single fault protection that allows the record to remain accessible even if one of the two databases goes down. Otherwise, if none of the redundancy policies 116 apply to the data record, shadow mode is said to be “disabled” and the record is maintained in either the first database 102 or the second database 104, but not both.

While shadow mode is enabled for a data record, a primary copy of the data record is maintained in the first database 102, which is assigned initial ownership of the data record. In the following disclosure, a database is described as “owning” a data record when the database is delegated the responsibility of executing incoming read/write requests targeting the data record. In response to determining that shadow mode is “enabled” for a given data record, the control layer 106 creates a replica referred to herein as a “shadow copy” of the data record that is stored in the second database 104, and all updates to the primary copy in the first database 102 are propagated, by the control layer 106, to the shadow copy in the second database 104. Data records maintained in “shadow mode” are eventually (and optionally) subjected to a record-specific policy-driven process referred to herein as “aging out,” which entails a transfer of ownership from the first database 102 to the second database 104. In some examples, aging out is further followed by a deletion of the primary record to free up storage capacity in the first database 102.

By design, an owner of the hybrid database system 100 may craft the redundancy policies 116 to enable shadow mode for data records that are, for various reasons, deemed high priority. If, for example, the hybrid database system 100 is designed to ingest event records logging telemetry anomalies, errors, and/or other problems in a network, it may be that certain event records are considered “high priority” (e.g., likely to be accessed and needed) for a period of time, such as 24 or 48 hours after they initially occur. In these and other scenarios, it may be desirable to afford the high priority records improved fault protection by storing them duplicatively in both databases for a period of time (e.g., until the records are no longer “high priority”) to ensure the records remain available in case one of the databases goes offline.

Improved fault protection is not the only benefit gained by the herein-disclosed shadow mode operations. Additionally, these shadow mode operations can simplify the process of migrating data between different database systems (e.g., upgrading a database) by phasing the data migration process into distinct time-separated stages—e.g., shadow copy creation, ownership transfer, and primary copy deletion, with each phase being time-staggered according to record-specific policies. Per the disclosed operations, the shadow mode copy is made while the primary copy remains accessible, allowing any errors in the copying processing to be identified and rectified without downtime in data access, as opposed to performing this debugging during a black-out period in which the user is unable to access data stored in the database system. Moreover, since the timing of these migration stages is driven by record-specific policies, various functionality (e.g., data management authority) can be gradually delegated to a new database in a controlled and error-free manner, allowing the new database to assume control of different subsets of the stored data records at different times as opposed to all at once. For example, a software team can investigate and rectify copying errors that occur (e.g., during schema translation) with respect to first type of data record and, when all errors are sufficiently addressed for that type of data record, ownership for that particular type of record can then be delegated to the new database while allowing other types of records to be remain owned by the old database. This practice allows the owner of the hybrid database system 100 to begin reaping benefits (e.g., reduced latency, reduced errors) of the new database sooner than in scenarios where the new database assumes ownership of all database records simultaneously.

In some implementations, the hybrid database system 100 is employed to operate the first database 102 and the second database 104 side-by-side, in perpetuity, to eliminate the task of re-working large quantities of code. If, for example, a business entity has a complex software stack that interfaces with an older database, it may be complex and risky to modify the software stack to interface directly with a newly-developed database. Instead, the business entity may elect to allow the network stack to continue to indefinitely interface with the older database by using the herein-described shadow mode operations to “age-out” records within the older database at designated (e.g., record-specific and policy-driven) points in time when those records are no longer likely to be accessed by network stack operations.

Each of the redundancy policies 116 specifies one or more characteristics of data records that the policy is applicable to. In one implementation, a redundancy policy identifies a data record type and applies to data records of the data record type. For example, each write request submitted to the control layer 106 identifies a data record and a “record type” parameter that is used to evaluate the redundancy policy. In one implementation, a redundancy policy identifies a request source and applies to data record write requests that are received from the request source. In still another implementation, a redundancy policy identifies a data priority level and the redundancy policy applies to data records that are assigned a corresponding priority level. For example, each write request submitted to the control layer 106 identifies a data record and a “priority” classifier assigned to the data record by the request source. Likewise, the write request may alternatively include other information that the policy evaluator and enforcer 126 can utilize to determine a priority level assigned to the data record.

After evaluating the redundancy policies 116 and determining whether shadow mode is enabled or disabled for a newly-received data record, the policy evaluator and enforcer 126 evaluates various record creation policies 108 to determine which of the two databases the data record is to be initially created (“birthed”) in. This database is said to be the initial owner of the data record with write access to the record and responsibility for executing each update to the data record that is received at the control layer 106. If, for example, a record creation policy indicates that a data record is to be birthed in the first database 102, the first database 102 is identified as the “initial owner” of the data record and all read and write requests targeting the record are thereafter directed to the first database 102 unless and until ownership is subsequently transferred to the second database 104.

Like the redundancy policies 116, the record creation policies 108 each specify conditions that, when satisfied by a data record write request, trigger application of the record creation policy to that write request. The record creation policies 108 dictate in which of the two databases each new data record 122 is to be the owner and serve as the birthplace for the data record. By example, some or all of the record creation policies 108 may specify characteristics of data records that the policy is applicable to. For example, a record creation policy identifies a source of the record (e.g., endpoint that the write request is received from), a date stamp associated with the record, a type of record (e.g., classification of the record itself such as a record pertaining to a particular type of event or type of file), or any other information that can be evaluated from contents of the write request and the data record itself.

Record creation policy conditions may vary dramatically depending upon the features of the two databases and the reasons that the hybrid database system 100 is employed. In one implementation where the hybrid database system 100 is employed to facilitate a database migration from an older database to a newer (e.g., higher capacity and/or better performing) database, the record creation policies 108 are closely coupled to the redundancy policies. For example, a record creation policy may provide that, if shadow mode is enabled for a particular data record, the older database is to serve as the birthplace for the data record and also be assigned initial ownership of the data record. In this case, the herein-disclosed operations allow the older database to remain online (with zero downtime) while data records in the originally database are gradually aged-out and thereafter managed within the newer database.

In another implementation, some or all of the record creation policies 108 depend on network conditions and/or system state variables accessible to the control layer 106. For example, a record creation policy may specify that new data records 122 are to be birthed in a primary database (e.g., the first database 102) so long as the first database is online and operational and, if the first database is offline and inaccessible, new data records 122 are to be birthed in a back-up database (e.g., the second database 104). This policy guarantees that all new records can be written at the time of their receipt even if the primary database is offline. Further, in this scenario, the herein-described shadow mode operations can be leveraged to automatically copy records written in the back-up database back to the primary database when access to the primary database is restored, and this can be followed by or performed concurrent to a policy-driven ownership transfer of such records back to the primary database.

Like the redundancy policies 116, the record creation policies 108 may each specify one or more characterstic(s) of the data records that are to be regarded as subject to the record creation policy. For example, a record creation policy may specify that data records from a particular source, of a particular type, or subject to a particular classification (e.g., high priority or low priority) are to be birthed in and owned by a specified one of the two system databases. In one implementation, the first database 102 is a primary, local database with high reliability and the second database 104 is a less-reliable cloud database (e.g., subject to occasional server outages) that is used to provide redundant storage of some data records. In this system, high-priority data records are created in the more reliable local database and copied, via the shadow mode operations, to the cloud database. In the same system, shadow mode operations may be selectively disabled for the lower priority records with record creation polic(ies) defined to birth the lower priority records in the less reliable cloud database. These exemplary policies provide desirable enhanced fault protection for the high priority records by reducing overall storage costs in exchange for lower fault protection for the lower priority records.

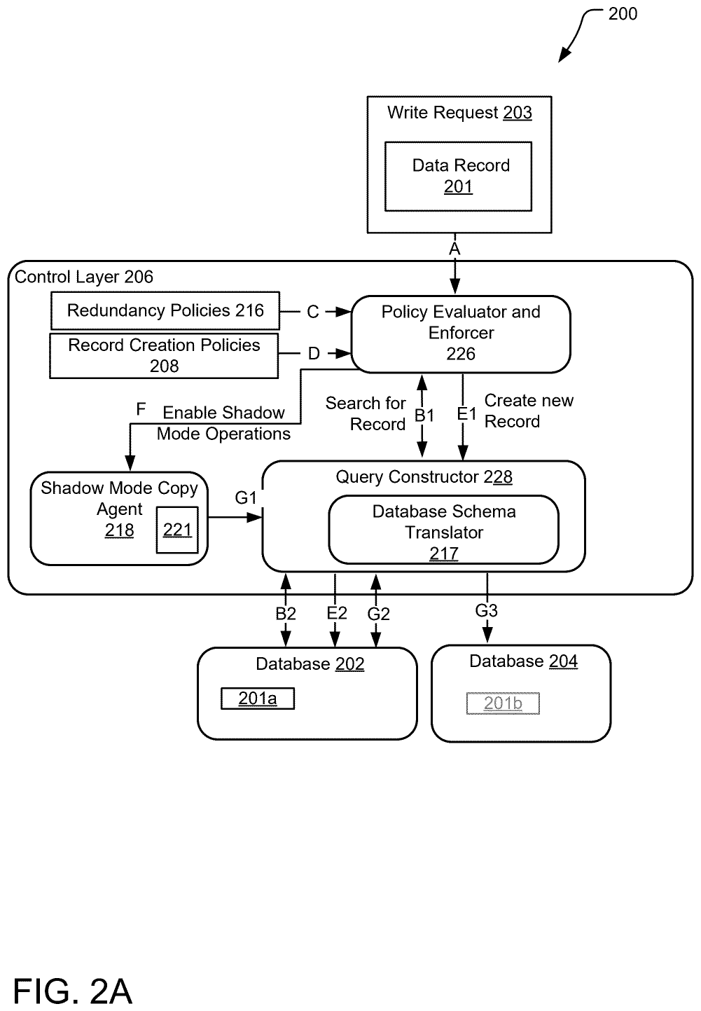

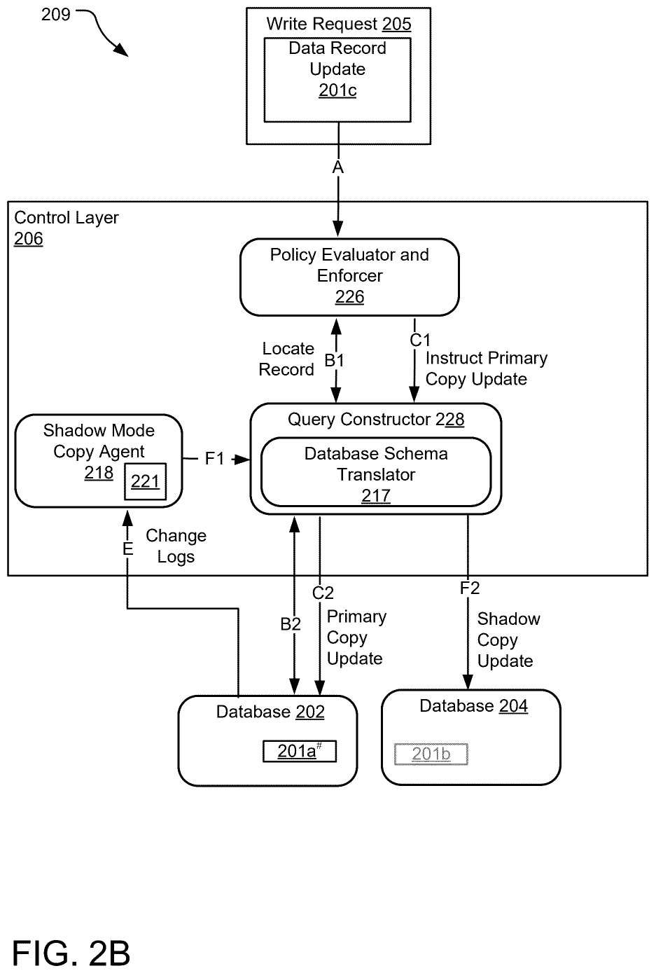

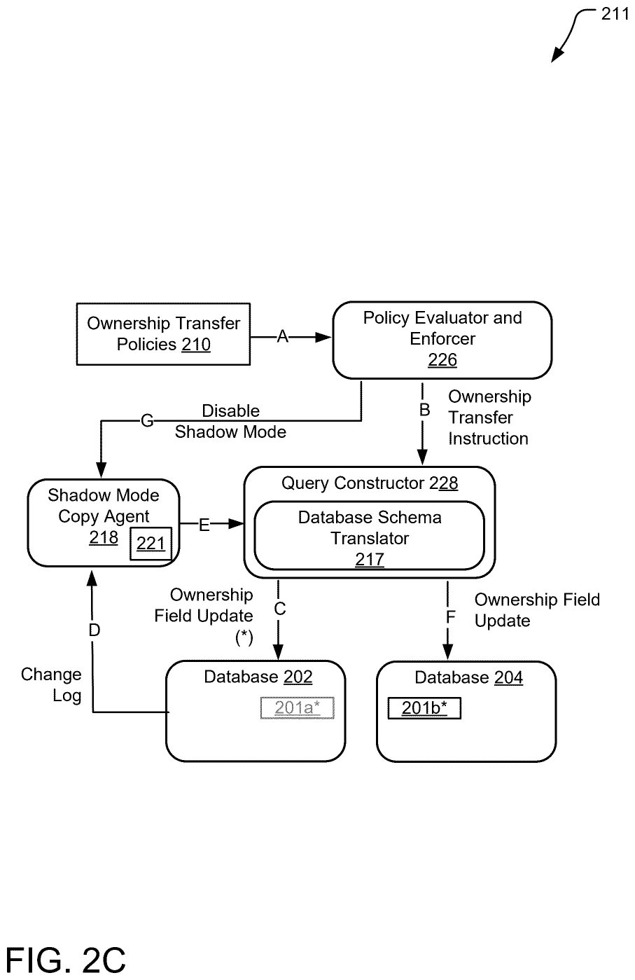

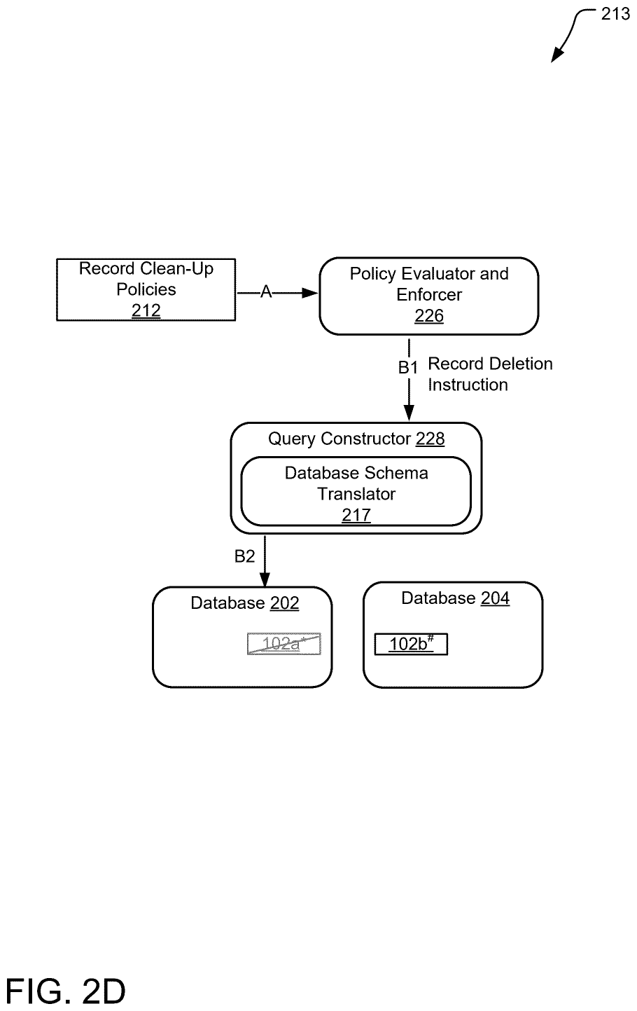

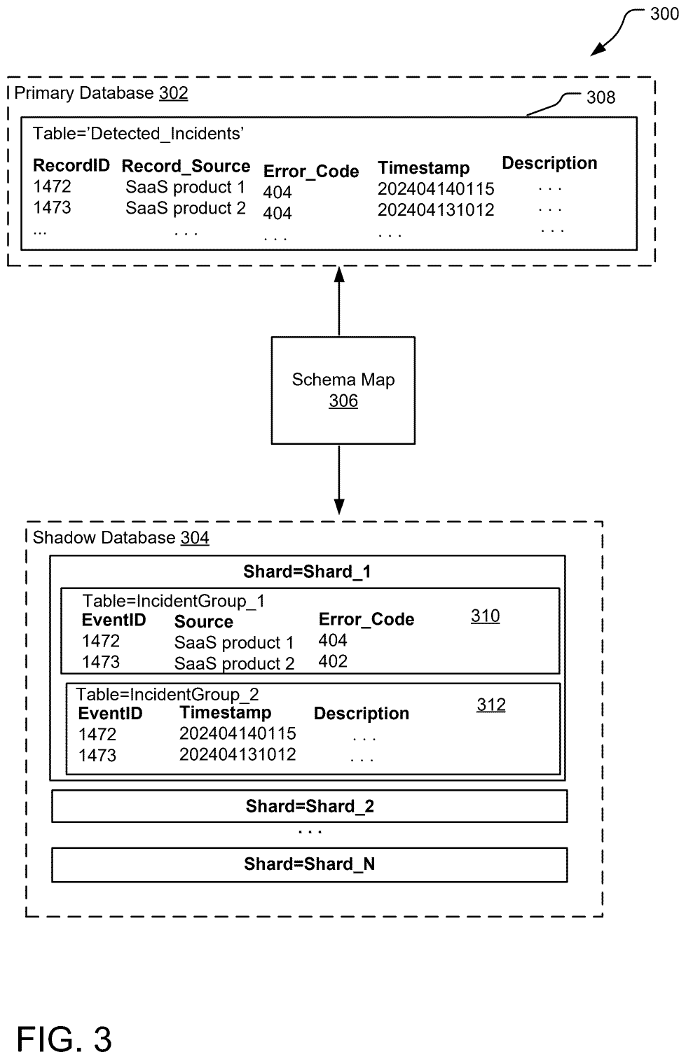

In addition to the policy evaluator and enforcer 126, the control layer 106 also includes a query constructor 128 and a shadow mode copy agent 118. The query constructor 128 performs database schema translation operations to effect reads and writes of both the first database 102 and the second database 104, as is further described with respect to FIG. 2A-2D and FIG. 3, below. The shadow mode copy agent 118 monitors the subset of data records subject to shadow mode operations to detect and automatically propagate changes between the primary and shadow copies of each of the data records.

The policy evaluator and enforcer 126 deploys additional agents to monitor conditions specified in various ownership transfer policies 110 and clean-up policies 112. In one implementation, each of the ownership transfer policies 110 specifies one or more characteristics of the data records that the policy is applicable to. Additionally, each of the ownership transfer policies 110 defines one or more conditions that, when satisfied by a data record subject to the policy, initiates a transfer of ownership for the data record between the first database 102 and the second database 104. In some implementations, an ownership transfer for a data record also serves to disable shadow mode operations for data record (meaning that following ownership transfer of a data record, new changes to the data record are no longer to be propagated from the primary copy to the shadow copy).

The conditions in the ownership transfer policies 110 are highly customizable and may vary in different implementations. In an example, one of the ownership transfer policies 110 specifies that ownership transfer is to occur when record(s) subject to the policy reach a set “age” since birth, such as 48 hours, one week, etc. By further example, another one of the ownership transfer policies 110 specifies that an ownership transfer is to occur for a data record having a particular characteristics (e.g., a given type of record or records from a particular source) in response to a determination that the data record has not been updated for a set period of time, such as one week, one month, etc., as this may indicate that the data is no longer hot/important enough to duplicatively maintain in both databases. By still further example, another one of the ownership transfer policies 110 may direct a transfer of ownership transfer in response to manually-provided command from a system operator. For example, the operator may provide a single command to initiate transfer of all records of a particular type.

Like the ownership transfer policies 110, each one of the clean-up policies 112 specifies characteristic(s) of the data records that the policy applies to and also specifies one or more conditions (“clean-up criteria”) that, when satisfied, trigger deletion of the data record from its birthplace database. In one implementation, a clean-up policy specifies that a certain type of data records are to be deleted in the first database 102 following elapse of a set period of time after ownership of the data record has been transferred (per one applicable one of the ownership transfer policies 110) to the second database 104. For example, ownership transfer to the second database 104 set sets a record-specific timer for a data record, and the data record is deleted from the first database when the timer elapses, such as a week after the ownership transfer has occurred. In other implementations, clean-up policies provide for immediate deletion of record from the first database 102 following ownership transfer to the second database 104.

Notably, different use case scenarios may drive conditions within the ownership transfer policies 110 and the record clean-up policies 112. For example, it may be that data is written to the first database 102 to provide data access to an immediate one-time process that interfaces directly with the first database 102 (e.g., an ingest operation that pulls data each minute). If, in this scenario, it is desirable for other processes to access the same data from the second database 104 as quickly as possible (e.g., to realize performance benefits of the second database 104 or otherwise),. In this case, an applicable ownership transfer polices may provide for transferring ownership to the second database five minutes after record creation. In this scenario, clean-up policies are also variable and highly customized. In one implementation, the data records are immediately (or within minutes) deleted from the first database 102 following ownership transfer to the second database 104. In another implementation where dual-database redundancy is desired for a period of time, an applicable clean-up policy may provide for waiting for a month, year, or other time period following the ownership transfer to delete the record in the first database 102.

Each data access request received from the client machine 114 is executed by a query constructor 128 that transforms the access request (e.g., a read or write request) into a query for the corresponding target database. In one implementation, the query constructor 128 includes a database schema translator (not shown) that performs schema translations between a first database schema used by the first database 102 and a second database schema used by the second database 104. In some implementations, the client machine 114 communicates with the hybrid database system 100 utilizing an API that exposes a public database schema that is different from the first database schema and the second database schema. In this case, the query constructor 128 is configured to translate read and write queries of the public database schema into corresponding read and write queries of both the first database schema and the second database schema.

At the point in time exemplified by FIG. 1, various data records A-G are shown at different respective stages in an age-out process. In this example, it is assumed that the redundancy policies 116 are set to initially enable shadow mode operations for each of data records A-G, and that the record creation policies 108 assign initial ownership of all of these records to the first database 102. When each of the records A-G is newly-received at the control layer 106 of the hybrid database system 100, a primary copy of the record is written in the first database 102 and the first database 102 is made the “owner” of the record-meaning, the first database 102 is given edit access to the records and delegated responsibility for executing incoming read/write requests targeting these records. Further, in response to creation of the primary copy of each of the data records A-G in the first database 102, the shadow mode copy agent 118 makes a shadow copy of the data record and stores that shadow copy in the second database 104. While the shadow mode operations remain enabled, the shadow mode copy agent 118 monitors change logs associated with the data records A-G to detect and to propagate changes between each primary copy and the corresponding shadow copy.

At the point in time exemplified by FIG. 1, the first database 102 remains the owner of data records A, B, and C, and shadow mode operations remain enabled for these records. However, ownership of records D-G has been transferred (in accord with applicable ownership transfer policies 110) from the first database 102 to the second database 104. In one implementation, this ownership transfer is effective to automatically disable shadow mode operations for these records. For example, an ownership transfer of record F from the first database 102 to the second database 104 causes further updates to record F to be delegated to and implemented on the second database 104 without propagating these changes back to the first database 102. In other implementations, ownership transfer is effective to reverse the direction of the shadow mode operations. For example, ownership of record F is transferred to the second database 104 and all future updates to record F implemented within the second database 104 are propagated to the corresponding copy residing in the primary database. Notably, some implementations may utilize record-specific policies to determine whether ownership transfer disables or reverses shadow mode for a given data record.

Returning to FIG. 1, records D and E are shown remaining in the first database 102 because the request conditions of corresponding, applicable record clean-up policies have not yet been satisfied. In contrast, clean-up conditions have been satisfied for records F and G, and these records have consequently been been deleted from the first database 102.

FIG. 2A-2D illustrate example record storage and migration operations in a hybrid database system that includes a first database 202, a second database 204, and a control layer 206. The first database 202 and the second database 204 store data according to different database schemas and may, in some implementations, be different types of databases. For example, the first database 202 is a single-server database and the second database 204 is a decentralized database that utilizes data sharding. Other characteristics of the first database 202, second database 204, and control layer 206 not specifically described below may be the same or similar as like-named components described with respect to FIG. 1.

FIG. 2A illustrate example operations 200 performed to write a new data record to the hybrid database system. At arrow “A”, a data record 201 is included in a write request 203 from a client application executing on an external compute system (not shown). In one implementation, the write request 203 is placed via an API of the control layer 206 that exposes a public database schema that is different than (e.g., simpler) than database schemas respectively utilized by the first database 202 and the second database 204. In this implementation, execution of the write request 203 entails translating the write request 203 into one or multiple rich database language queries compliant with the schema(s) and database language(s) (e.g., MYSQL) used by the first database 202 and the second database 204. In other implementations, the write request 203 is formatting according to a same database language and schema as that used by one of the first database 202 and the second database 204.

In response to receiving the data record 201, a policy evaluator and enforcer 226 performs operations to determine whether or not the data record 201 already exists in the hybrid database system.

First, the policy evaluator and enforcer 226 delegates a read instruction to the query constructor 228. This read instruction and the subsequent response are, in FIG. 2A, represented by bidirectional arrow “B1.” The read instruction includes a data record identifier that uniquely identifies the new data record 201 and that corresponds to a field that is indexed and searchable within the first database 202 and the second database 204. In response to the read instruction, the query constructor 228 constructs and transmits a read query that includes the data record identifier and that is formatted according to the language and schema utilized by the first database 202. This read query and the corresponding subsequent response are represented in FIG. 2A by bidirectional arrow “B2.” A database management system (DBMS) of the first database receives and executes the read query that includes the data record identifier for the data record 201 and, in response, returns a null dataset (e.g., an indication that the data record identifier does not match an existing record in the first database 202). This response from the first database 202 is conveyed back to the policy evaluator and enforcer 326 (along arrow B1). Based on this response, policy evaluator and enforcer 226 determines that the data record 201 does not yet exist in the hybrid database system.

Although not shown, the policy evaluator and enforcer 226 may, in some implementations, query the second database 204 based on the data record identifier (e.g., as described above with respect to the first database 202) to determine if the new data record 201 resides in the second database 204. The need for this additional read operation depends upon implementation-specific details including whether the hybrid database system stores new data records 201a,b in one or both of the two databases and also whether the first database 202 and the second database 204 locally index data record identifiers usable to identify data records that have been transferred to the other one of the two databases and locally deleted. Various methods to “check” whether a data record exists in one or both databases are well known and within the level of skill in the art.

In response to determining that the data record 201 does not yet exist, the policy evaluator and enforcer 226 begins searching and evaluating policies to determine where and how the data record 201 should be written.

At arrow “C”, the policy evaluator and enforcer 226 reads and evaluates redundancy policies 216 to determine which, if any, of the redundancy polices 216 is applicable to the write request. Each of the redundancy policies 216 identifies whether shadow mode operations are “enabled” or “disabled” for the subset of write requests subject to the policy.

In various implementations, different redundancy policies may be based on one or more of record type, record source, record age, an assigned record priority parameter or other parameter identified in the write request 203 or information identified by or within the data record 201. In one implementation, evaluating the redundancy policies 216 entails comparing one or more characteristics identified in a given redundancy policy to characteristics of the write request (e.g., characteristics of information included in the write request 203 and/or the data record 201). For example, the policy evaluator and enforcer 226 determines that a source of the write request 203 matches a request source identified in a select redundancy policy and based on this, determines that the policy is applicable. In the example shown, it is assumed that the policy evaluator and enforcer 226 identifies an applicable redundancy policy 216, which indicates that shadow mode operations are enabled for the write of the data record 201.

In some implementations, there are no redundancy policies to evaluate and the control layer 206 instead applies a default rule that enables shadow mode operations for all new records. In the example shown, it is assumed that the policy evaluator and enforcer 226 one of the redundancy policies 216 that enables shadow mode operations for the data record 201.

At arrow D, the policy evaluator and enforcer 226 additionally evaluates record creation policies 208 to determine which database should receive the data record 201 and become the owner of a primary copy of the record. The owner is tasked with executing all read/write commands received at the hybrid database system that target the data record. In one implementation, the hybrid database system enforces a first record creation policy when writing new records for which shadow mode has been “enabled” and enforces a second different record creation policy when writing new record that have shadow mode “disabled.” For example, records with shadow mode enabled are written to the first database 202 while records with shadow mode disabled are to be written to the second database 204. In other implementations, the evaluation of the record creation policies 208 entails comparing characteristic(s) of the data record 201 and/or other information in the write request 203 to characteristics identified within record creation policies 208 to determine which, if any, of the redundancy polices 216 is applicable to the write request. For example, the record creation policies 208 may (like the redundancy policies 316) be based on one or more of record type, record source, record age, record priority, other information identified within the write request 203 or the data record 201. In some implementations, select record creation policies include conditions that depend on network state information. For example, a first record creation policy may apply to the data record 201 when the first database 202 is online and operational and a second different record creation policy may apply to the data record 201 when the first database 202 cannot be reached.

In the illustrated example, it is assumed that the policy evaluator and enforcer 226 identifies an applicable record creation policy for the data record 201 that provides for record creation the data record in the first database 202. In response to this, the policy evaluator and enforcer 226 delegates a write instruction (at arrow E1) to the query constructor 228. The query constructor 228 interprets the write instruction as a request to write the data record 201 to the first database 202 and to mark the data record in the first database 202 in a way that identifies the first database 202 as the owner of the data record 201. At arrow E2, the query constructor 228 transmits a write query to the first database 202 effective to execute the write instruction represented by arrow E1. The write query is composed in a database language used by the DBMS of the first database 202 and according to a schema of the first database 202. The DBMS of the first database 202 executes the write query, creating a copy of the data record 201—referred to below as “primary copy 201a.” In FIG. 2A, a hash-tag superscript symbol (#) is used to indicate that the primary copy 201a is marked as “owned by” the first database 202.

In addition to instructing the write of the primary copy 201a of the data record 201 in the first database 202 as described above, the policy evaluator and enforcer 226 also transmits a shadow mode enablement instruction (shown by arrow F) to a shadow mode copy agent 218. The shadow mode enablement instruction instructs the shadow mode copy agent 218 to enable shadow mode operations for the data record 201. Notably, another way of enabling/disabling shadow mode operations is to enable shadow mode operations by default for all records owned by the first database 202 and to likewise not enable shadow mode operations for the records owned by the second database 204. In this implementation, there is no transmission of the “shadow mode enablement instruction” illustrated by arrow F and there is no need to maintain a listing of which records have shadow mode enabled (described below as “shadow mode index 221”). Instead, changes to records in the first database 202 are simply disallowed for records that have been subject to ownership transfers to the second database 204.

Returning to the flow of FIG. 2A: in response to receiving the shadow mode enablement instruction at arrow F, the shadow mode copy agent 218 stores a data record identifier for the data record 201 in a shadow mode index 221 and communicates (at arrow G1) a shadow copy write instruction to the query constructor 228. The shadow copy write instruction instructs the query constructor 228 to use a data record identifier for the data record 201 to pull the primary copy 201a of the data record 201 from the first database 202 and to create a copy of data record 201 in the second database 204. The query constructor 228 executes the shadow copy write instruction by reading the primary copy 201a from the first database 202 (e.g., by querying based on the data record identifier). This read and the corresponding response are represented by arrow G2. The query constructor 228 then uses the data returned in the read query (at G2) to construct a write query instructing a DBMS of the second database 204 to create a new data record, indexed by the data record identifier of the data record 201, that includes all information stored in the primary copy 201a. This write query is represented by arrow G3.

Since the first database 202 and the second database 204 utilize different database schemas, a database schema translator 217 is employed to map data values of the primary copy 201 received from the first database 202 to corresponding schema elements defined within the schema of second database 204 that are, in turn, used to construct the corresponding write query (at G3). In one implementation, this schema translation entails mapping values pulled from respective tables and fields of the first database 202 to different tables and/or fields of the second database 204. Based on the above operations, the second database 204 creates and stores a copy of the data record 201—referred to below as “shadow copy 201b.”

FIG. 2B illustrates further example operations 209 of the hybrid database system of FIG. 2A that are performed to update the data record 201 while the first database 202 remains the owner of the data record. At arrow A, the control layer 206 receives a write request 205 that includes an update to the data record 201 that has, per operations of FIG. 2A, been written to the hybrid database system. This update is shown as “data record update 201c.”

In response to the write request 205, the policy evaluator and enforcer 226 executes operations to locate the record. First, the policy evaluator and enforcer 226 instructs the query constructor 228 to locate the data record 201 and determine the owner of the data record 201. This instruction and (a corresponding subsequently-generated response are represented by arrow B1). Upon receipt of the instruction (represented by arrow B1), the query constructor 228 attempts to locate a matching data record by querying one or both of the databases based on a data record identifier specified within the write request 305. In FIG. 2C, arrow B2 represents a read query transmitted from the query constructor 228 to the first database 202 and corresponding database response subsequently received from a DMBS of the first database. This read query includes the data record identifier included in the write request 205 and is constructed in the schema and database language utilized by the first database 202. The database response to this read query identifies an existing record (the primary copy 201a) in the first database 202 that is stored in association with a matching data record identifier and that has been marked as “owned by” the first database 202 (with ownership being denoted in FIG. 2B by the hash-tag superscript (#).

A confirmation of the matching data record is then transmitted back to the policy evaluator and enforcer 226 (along arrow B1). In response (at arrow C1), the policy evaluator and enforcer 226 transmits a communication that serves to instruct the query constructor 228 to delegate execution of the write request 205 to the first database 202. In response, the query constructor 228 constructs and transmits a corresponding write query (at arrow C2) in the database language of the first database 202 and according to the schema utilized by the first database 202. In response, the DBMS of the first database 202 executes the query, updating the primary copy 201a to include changes specified in the data record update 201c.

When the primary copy 201a is updated in the first database 202, the first database 202 creates and stores a change log that identifies each change. The shadow mode copy agent 218 monitors change logs (as shown by arrow E) that are created by the first database 202 to detect changes made to the subset of records for which the shadow mode operations have been enabled (e.g., the set of records identified within the shadow mode index 221). In response to determining, based on the change log, that the primary copy 201a has been updated, the shadow mode copy agent 218 transmits a communication (at F1) that instructs the query constructor 228 to propagate the changes made to the primary copy 201a to corresponding data of the shadow copy 201b residing in the second database 204. In response to this communication, the database schema translator 217 identifies schema element(s) associated with each updated value identified in the change log and accesses a mapping to map these schema elements to corresponding schema elements defined within the second database 204. For example, the change log identifies each updated data value by an associated a record ID, table ID, and field ID that are all associated, via the mapping, with a record ID, table ID, and field ID used to reference the corresponding data value in the second database 204. Based on the mapping, the query constructor 228 constructs a write instruction (shown by arrow F2) in the schema of the second database that instructs the DBMS of the second database 204 to update shadow copy 201b to match the now-updated primary copy 201a. In this way, the shadow copy 201b is dynamically updated to match the primary copy 201a each time the primary copy 201a is updated.

FIG. 2C illustrates additional example operations 211 performed by the hybrid database system of FIG. 2A-2B to initiate an “age-out” process for the data record 201. The age-out process begins with an ownership transfer from the first database 202 to the second database 204. During nominal database operations, the policy evaluator and enforcer 226 deploys various watchdog agents to continuously monitor and detect satisfaction of ownership transfer criteria specified in each of multiple record-specific ownership transfer policies 210 (generally illustrated by arrow A) with respect to the subset of data records stored on the shadow mode index 221.

Each of the ownership transfer policies 210 identifies characteristic(s) of data records subject to the policy and ownership transfer criteria that when satisfied with respect to an individual record, trigger transfer of ownership for that data record. For example, one of the ownership transfer policies 210 indicates that all records of a given event type or assigned primary level are to be subject to ownership transfers exactly 1 week after being birthed (initially written) in the hybrid database system.

In response to determining that the ownership transfer criteria are satisfied for the data record 201 (which appears on the shadow mode index 221), the policy evaluator and enforcer 226 transmits an ownership transfer instruction to the query constructor 228 (as shown by arrow B). The ownership transfer instruction includes the data record identifier for the data record 201 and generally instructs a transfer of ownership for the data record 201. In response, the query constructor 228 performs operations to determine which database owns the primary copy 201a of data record 201. In one implementation, the record itself includes a ownership field that indicates which of the databases (e.g., the first database 202 or the second database 204) is the current owner of the record, and only the current owner has permission to implement externally-received updates to the data record. In response to determining that the first database 202 is the current owner of the data record, the query constructor 228 transmits a first record marking instruction to the first database 202, represented by arrow C. This first record marking instruction instructs the DBMS of the first database 202 to mark the primary copy 201a as transferred to signify it is no longer owned by the first database 202. In one implementation, this marking is achieved by updating an ownership field of the data record to identify the second database 204 (the new owner) instead of the first database 202 (the first owner).

The ownership change to the data record 201a is propagated to the second database 204 via the above-described shadow mode operations. First, the ownership change to the data record 201 is captured in a change log of the first database 202, and the change log is picked up by the shadow mode copy agent 221 (as shown by arrow D). The shadow mode copy agent 218 then propagates this change to the data record to the second database 204, as shown by arrows E and F (per shadow mode operations generally as described above with respect to FIG. 2B). Since the second database 204 is now the owner of the data record 201, externally-received updates to the data record can, at this point in time, be updated exclusively by the second database 204.

As a result of these operations, the second database 204 becomes the owner of the data record 201, meaning that all future incoming reads/writes targeting the data record 201 are delegated to the second database 204 for execution. Effectively, the shadow copy 201b now functions as the primary copy.

In addition to initiating the above-described ownership transfer and in response to determining that the ownership transfer criteria are satisfied for the data record 201, the policy evaluator and enforcer 226 also instructs the shadow mode copy agent 218 to disable shadow mode operations. This instruction is shown by arrow G. In response, the shadow mode copy agent 218 disables shadow mode operations for the data record 201, such as by removing the data record identifier for the data record 201 from the shadow mode index 221, or by other suitable action. Following the above-described actions, future updates to the data record 201 are directed to and executed by the second database 204, and these updates are not propagated back to the first database 202. Consequently, the primary copy 201a becomes stale and the shadow copy 201b now serves as the primary copy of the data record 201.

In an alternate implementation, the policy evaluator and enforcer 226 instructs the shadow mode copy agent 218 to reverse (rather than disable) the shadow mode operations, such that future updates to the data record 201 written to the second database 204 are propagated back to the first database 202. This reversal of the direction of the “shadowing” may beneficially provide ongoing enhanced fault protection for the data record 201 for a period of time following the ownership transfer, which may be desirable if, for example, the second database 204 is a newer database with superior performance characteristics. Notably, this example applies to a scenario where the data record is not written directly to the second database 204 initially because it is, for some reason, needed in the first database 202 for a period of time immediately following its birth.

In some implementations, default rules and/or selective ownership transfer policies provide for deleting the original primary copy of the data record in the first database 202 at the same time ownership of the record is transferred to the second database 204 (or immediately following this ownership transfer). However, there exist scenarios where it may be desirable to allow the primary copy 201 to continue to reside in the first database 202 for a period of time following ownership transfer. For example, it may be more power-efficient to periodically execute batch jobs to clean-up multiple records at once than to delete such records one-by-one in association with ownership transfers. In these and other scenarios, exemplary operations of FIG. 2D govern record clean-up.

FIG. 2D illustrates example operations 213 performed by the hybrid database system of FIG. 2A-2C to complete the “age-out” process described in FIG. 2C by deleting the original primary copy of data record 201 from is birthplace (e.g., the first database 202) after the data record 201 has been subject to an ownership transfer, as generally described with respect to FIG. 2C above.

During nominal database operations, the policy evaluator and enforcer 226 deploys various watchdog agents to continuously monitor and detect satisfaction of conditions specified in each of multiple record-specific ownership record clean-up policies 212 (generally illustrated by arrow A). Each one of the record clean-up policies 212 identifies characteristic(s) of data records that subject to the policy and one or more conditions that, when satisfied with respect to an individual record, trigger deletion of a copy of that data record. For example, one of the record clean-up policies 212 indicates that all records of a given event type or assigned primary level are to be subject to clean-up operations one month after being respectively subjected to an ownership transfer, as described above with respect to FIG. 2C.

In response to determining that the record clean-up condition(s) are satisfied for the data record 201, the policy evaluator and enforcer 226 transits an ownership transfer instruction to the query constructor 228 that includes the data record identifier for the data record 201 and that instructs deletion of the data record from the database that is not the current owner of the data record. In response, the query constructor 228 executes the instruction (at arrow B2) by querying one or both databases to locate the copy of the data record that is marked as transferred (*) and no longer owned by the database in which it resides. Once this record is identified in the database 202, the query constructor 228 deletes the record from the database 202, freeing up storage capacity.

FIG. 3 illustrates exemplary aspects of a hybrid database system 300 with characteristics the same or similar to those described with respect to any of FIG. 1 or FIG. 2A-2D. Specifically, FIG. 3 illustrates exemplary aspects of a first database referred to as the “primary database 302”, a second database referred to as a “shadow database 304.” Changes made to the primary database 302 are, using the herein-disclosed methodology, propagated to the shadow database 304 using a schema map 306.

In the example shown, the primary database 302 is a centralized (single-server) database that stores one or more tables. Table 308 is shown to illustrate example elements of the database schema used by the primary database 302. Specifically, the table 308 has a title “detected incidents” and stores event records that each include information characterizing or describing an event detected within a computer network. By example, the table 308 is shown to include a first field “RecordID” that stores numeric event record identifiers and a second field “Record Source” that stores string values that identify various sources that submit record events to the hybrid database system 300. For example, ‘SaaS product 1’ and ‘SaaS product 2” identify services within a cloud platform that have detected events and submitted corresponding event records to the hybrid database system. Although not shown, another table in the primary database 302 maps each of the named services to corresponding source IP addresses that physically appear within packet headers of various record write request received at the hybrid database system 300. The table 308 additionally includes a data field “error code” describing an error code observed in association with each event, “Timestamp” that stores a numeric value indicating a date/time of event detection, and a data field “Description” that stores descriptive information about each event.

The shadow database 304 is a decentralized database with multiple different servers that each store and locally manage a shard of database data corresponding to a subset of the data stored within the primary database 302. The shadow database 304 has a different schema that the first database but designed to receive and store the same event records. However, because the shadow database 304 stores data in shards, the events records that are stored together in the table 308 of the primary database 302 are stored on different servers (e.g., as part of different data shards) within the shadow database 304. For example, the shadow database 304 includes a first server that stores a first shard (“Shard_1”), a second server that stores a second shard (“Shard_2”), etc. Each different shard stores a different subset of the event records that are all stored together in the table 308 of the primary database 302.

In the example shown, the first shard of data (“Shard_1”) stores two tables-a first table 310 and a second table 312, each of which stores a different subset of fields for a same subset event. Notably, some field names used in the shadow database 304 are different from corresponding fields names that store the same type of information in the primary database 302. For instance, the first table 310 stores a first field EventID which corresponds to the RecordID field of table 308; a second field Source which corresponds to the “Record Source” field of the table 308; and a third field Error_code which is named identically to the corresponding field in the table 308. The second table 312 uses the same EventID field name to reference the values stored in the RecordID column of the table 308, and also stores Timestamp and Description fields, which are named identically to corresponding field names in the table 308.

The database schema map 306 includes information usable to map first schema components (e.g., table names, fields) of the primary database 302 to second schema components (e.g., shards, table names, fields) of the shadow database 304, allowing each data field value stored in a table of the primary database 302 to be mapped to a corresponding cell defined within one of the shards of the shadow database 304. In one implementation, the database schema map 306 is used by the database schema translator 217 of FIG. 2A-2D to construct database queries executable to propagate an update to primary copy of a data record within the primary database 302 to a corresponding shadow copy of the same data records that is stored and maintained in the shadow database 304, such as in accord with the operations generally described elsewhere herein.

In the example shown, it is assumed that the schema map 306 contains a mapping that maps each of the event records appearing the primary database 302 to a corresponding shard in the shadow database 304. In addition to mapping event records to shards, the schema map 306 also maps each value in the table 308 to one or multiple different tables and fields in the corresponding shard. For example, the RecordID value “1472” is mapped to a first cell referenced by the EventID field name in the first table 310 and to a second cell also referenced by the EventID field name in the second table 312. Likewise, the value of Error_Code for the record with RecordID=1472 is mapped to a corresponding cell referenced by Error_Code in the first table 310, and the value of “Timestamp” for this same record is mapped to a corresponding cell referenced similarly in the second table 312.

In this general manner, each value that is referenced by a first collection of schema components defined in the primary database 302 can be mapped to a cell that resides in the shadow database and that is defined by a second collection of schema components defined with the shadow database 304.

In real-world scenarios, schema mappings are complex and-despite testing—are often a source of unexpected data transfer errors that occur during data migrations between databases of different schema. However, since the herein disclosed hybrid database storage systems introduce a degree of temporal separation between the copying of each record (e.g., the creation of the shadow mode copy) and the ownership transfer of each record, errors that occur as a result of schema mapping and shadow copy creation (or update) can be addressed while the primary copy of each affected record remains accessible to the end user. Moreover, since this degree of temporal separation between shadow copy creation and ownership transfer can be controlled at a per-record granularity, it is possible to configure a new database to assume gradual control of increasing numbers of data records—allowing performance benefits of the new database to be leveraged more quickly than if the entire database were migrated and “switched on” all at once.

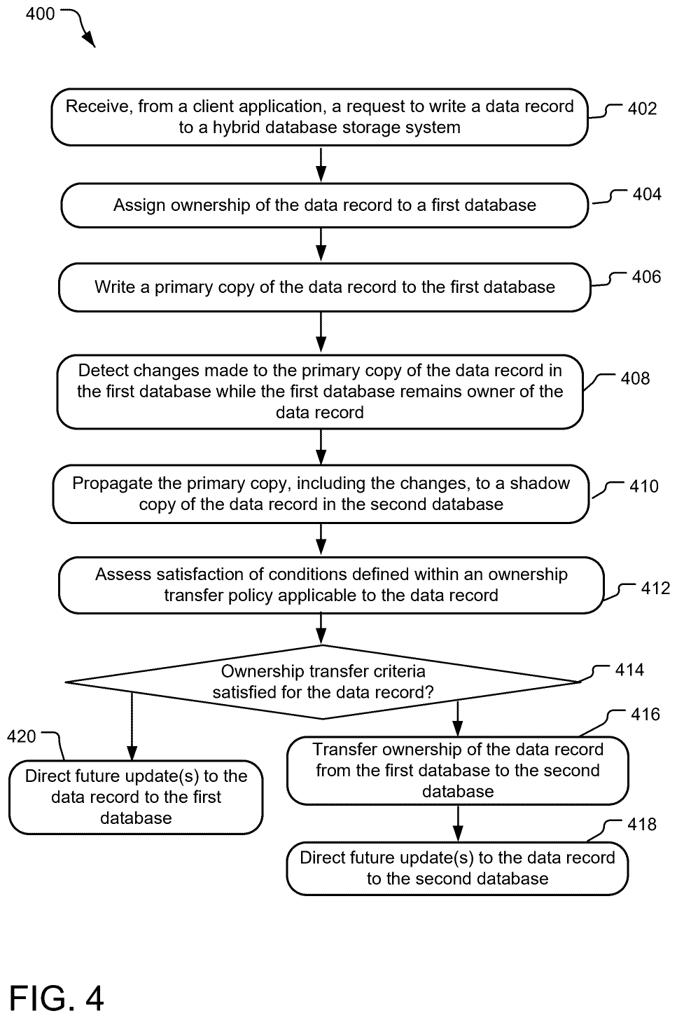

FIG. 4 illustrates example operations 400 for data management within a storage system with a hybrid database architecture that includes a first database, a second database, and a control layer that determines where to direct each database access request based on record-specific policies, such as a policies that pertain to redundancy, record creation, ownership transfer, and/or clean-up. In one implementation, the operations 400 are performed by the control layer.

A data receipt operation 402 receives, from a client application, a request to write a data record to the hybrid database storage system. An ownership assignment operation 404 assigns ownership of the data record to the first database. In one implementation, the ownership assignment is performed based on a default system rule (e.g., a rule that designates the first database as the owner of all new records). In other implementations, the ownership assignment is performed based on identification and assessment or more applicable redundancy policies and/or record creation policies as generally described herein with respect to any of FIG. 1-3.

An initial record write operation 406 writes a primary copy of the data record to the first database (e.g., the designated owner). A change detection operation 408 detects changes made to the primary copy of the data record in the first database while the first database remains the owner of the data record, and a propagation operation 410 propagates the primary copy of the data record, including the changes, to a shadow copy in the second database. In one implementation, the change detection operation 408 and the change propagation operation 410 entail monitoring change logs created by the first database and performing database schema translations. For example, the database schema operations entail mapping each updated value identified in the change logs of the first database to a set of schema components defined within the second database that are usable to uniquely reference a corresponding cell in the second database.

A policy assessment operation 412 assesses satisfaction of conditions defined within an ownership transfer policy applicable to the data record. In one implementation, the ownership transfer policy identifies characteristic(s) of data records subject to the policy and ownership transfer criteria that, when satisfied with respect to an individual record, trigger transfer of ownership for that data record. For example, the ownership transfer policy provides that all data records from a particular source (e.g., internet-based endpoint) are to be subject to ownership transfers one month after their initial creation within the hybrid database system.

Based on the policy assessment operation 412, a determination operation 414 determines whether ownership transfer criteria are satisfied for the data record. If so, an ownership transfer operation 416 transfers ownership of the data record from the first database to the second database and a routing operation 418 directs future updates to the data record to the second database instead of the first database. Otherwise, ownership remains unchanged and a routing operation 420 continues directing future updates to the data record to the first database.

In some implementations, the operations 400 further provide for deleting the primary copy of the data record from the first database concurrent with or subsequent to the ownership transfer operation 416. This optional “clean-up” operation may be subject to conditions defined within an applicable record-specific clean-up policy, as discussed with respect to at least FIG. 2D.

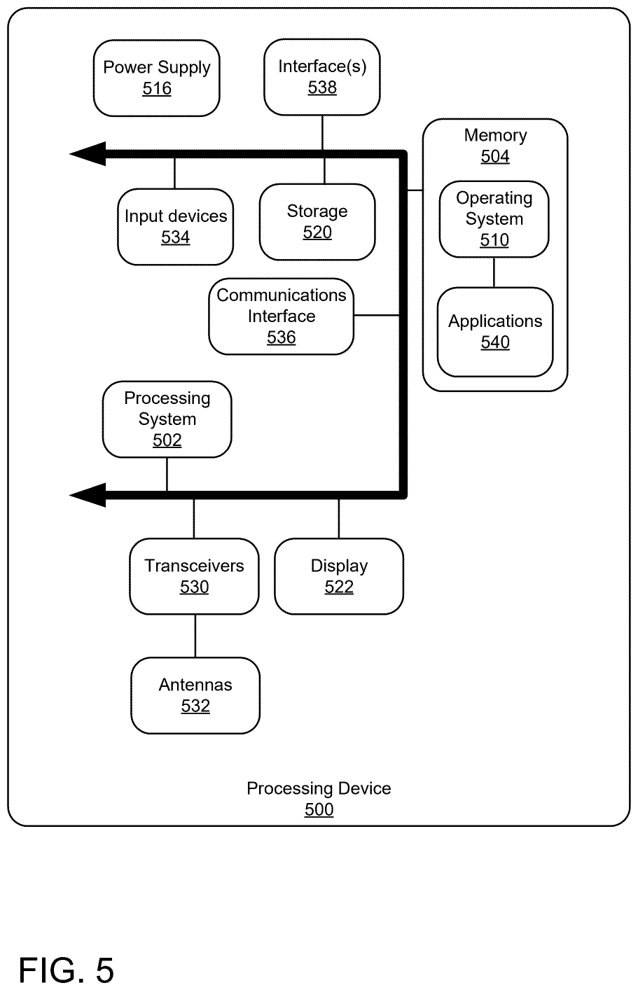

FIG. 5 illustrates an example schematic of a processing device 500 suitable for implementing aspects of the disclosed technology. The processing device 500 includes a processing system 502, memory 504, a display 522, and other interfaces 538 (e.g., buttons). The processing system 502 may each one or more computer processing units (CPUs), graphics processing units (GPUs), etc.

The memory 504 generally includes both volatile memory (e.g., random access memory (RAM)) and non-volatile memory (e.g., flash memory). An operating system 510 resides in the memory 504 and is executed by the processing system 502. One or more applications 540 (e.g., the policy evaluator and enforcer 126 of FIG. 1, the shadow mode copy agent 118 of FIG. 1, and the query constructor 128 of FIG. 1) are loaded in the memory 504 and executed on the operating system 510 by the processing system 502. In some implementations, aspects of the control layer 106 FIG. 1 are loaded into memory of different processing devices connected across a network. The applications 540 may receive inputs from one another as well as from various input local devices 534 such as a microphone, input accessory (e.g., keypad, mouse, stylus, touchpad, gamepad, racing wheel, joystick), or a camera.

Additionally, the applications 540 may receive input from one or more remote devices, such as remotely-located servers or smart devices, by communicating with such devices over a wired or wireless network using more communication transceivers 530 and an antenna 432 to provide network connectivity (e.g., a mobile phone network, Wi-Fi®, Bluetooth®). The processing device 500 may also include one or more storage devices 520 (e.g., non-volatile storage).

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method including: receiving, at a hybrid database storage system, a write request for a data record; in response to receipt of the write request for the data record, assigning ownership of the data record to a first database of the hybrid database storage system; writing a primary copy of the data record to the first database of the hybrid database storage system; while the first database retains ownership of the data record, detecting changes to the primary copy of the data record made in the first database and propagating the changes to a shadow copy of the data record to a second database of the hybrid database storage system; transferring ownership of the data record from the first database to the second database; and subsequent to transferring ownership, directing updates to the data record to the second database.

In some aspects, the techniques described herein relate to a method, further including: identifying, from a plurality of stored ownership transfer policies, an ownership transfer policy that applies to the data record and that defines one or more ownership transfer criteria; and transferring the ownership of the data record in response to determining the one or more ownership transfer criteria are satisfied for the data record.

In some aspects, the techniques described herein relate to a method, further including: subsequent to transferring ownership of the data record from the first database to the second database, identifying a clean-up policy applying to the data record from a plurality of clean-up policies stored in association with different data records or data record characteristics, the clean-up policy defining clean-up criteria applicable to the data record; and in response to determining that the clean-up criteria are satisfied for the data record, implementing the clean-up policy by deleting the data record from the first database.

In some aspects, the techniques described herein relate to a method, further including: in response to receiving the data record at a control layer, identifying, based on one or more characteristics of the data record, at least one of a record creation policy and a redundancy policy applicable to the data record; and based on at least one of the record creation policy or the redundancy policy: designating the first database as a primary database to execute access requests targeting the data record; and designating the second database as a shadow database to store the shadow copy of the data record and update the shadow copy based on change logs documenting updates to the primary copy of the data record in the first database.

In some aspects, the techniques described herein relate to a method, further including: evaluating one or more characteristics of the data record to identify an ownership transfer policy applicable to the data record from a plurality of ownership transfer policies defined for different data records in the hybrid database storage system, the ownership transfer policy defining the ownership transfer criteria for the data record.

In some aspects, the techniques described herein relate to a method, wherein the first database stores data according to a first database schema and the second database stores data according to a second database schema and wherein propagating the changes to the shadow copy of the data record includes: receiving a change log from the first database, the change log identifying one or more updated values and corresponding database schema components of the first database schema; utilizing a schema mapping to map the one or more updated values of the first database schema to corresponding database schema components of the second database schema; and based on the schema mapping, constructing a write query to update the shadow copy of the data record according to the second database schema.

In some aspects, the techniques described herein relate to a method, wherein transferring ownership of the data record includes marking at least one of the primary copy of the data record and the shadow copy of the data record to indicate that the second database is now owner of the primary copy of the data record.

In some aspects, the techniques described herein relate to a method, wherein directing updates to the data record to the second database without updating data in the first database further includes: receiving an update request to update the data record; in response to the update request, constructing and transmitting a read request to at least one of the first database and the second database; based on data received in response to the read request, determining whether the data record exists and whether the data record is owned by the first database or the second database; in response to determining that the data record exists and is owned by the second database, constructing and transmitting a write query to update the data record in the second database.

In some aspects, the techniques described herein relate to a method, further including: in response to assigning ownership of the data record to the first database, adding an identifier of the data record to a shadow mode index; and monitoring changes made to a primary copy of each data record in the shadow mode index; in response to detecting a change to a primary copy of a select data record identified in the shadow mode index, propagating the change to a corresponding shadow copy of the data record that is stored in a different database than the primary copy.

In some aspects, the techniques described herein relate to a hybrid database storage system including: a first database; a second database; and a control layer that: receives a request to write a data record; assigns ownership of the data record to the first database; instructs the first database to store a primary copy of the data record; while the first database retains ownership of the data record, detects changes to the primary copy of the data record in the first database and propagates the changes to a shadow copy of the data record in the second database; transfers the ownership of the data record from the first database to the second database in response to determining one or more ownership transfer criteria are satisfied for the data record; and while the second database retains ownership of the data record, directs updates to the data record to the second database.

In some aspects, the techniques described herein relate to a hybrid database storage system, wherein the control layer: identifies and evaluates clean-up criteria applicable to the data record; in response to determining that the clean-up criteria are satisfied for the data record, deletes the data record from the first database.

In some aspects, the techniques described herein relate to a hybrid database storage system, wherein the clean-up criteria for the data record are defined in a clean-up policy maintained by the hybrid database storage system among a plurality of clean-up policies, and wherein the control layer identifies an applicable one of the plurality of clean-up policies based on characteristics of the data record.

In some aspects, the techniques described herein relate to a hybrid database storage system, wherein the control layer: based on one or more characteristics of the data record, at least one of a record creation policy and a redundancy policy applicable to the data record; and based on at least one of the record creation policy and the redundancy policy, designates the first database as a primary database and the second database as a shadow database, wherein the primary database is the owner of the data record.

In some aspects, the techniques described herein relate to a hybrid database storage system, wherein the control layer: evaluates one or more characteristics of the data record to identify an ownership transfer policy that applies to the data record from a plurality of ownership transfer policies defined for different data records in the hybrid database storage system, the ownership transfer policy defining the one or more ownership transfer criteria for the data record.

In some aspects, the techniques described herein relate to a hybrid database storage system, wherein the first database stores data according to a first database schema and the second database stores data according to a second database schema and wherein the control layer propagates the changes to the shadow copy by performing operations that include: receiving a change log from the first database, the change log identifying one or more updated values within the data record and corresponding database schema components of the first database schema; utilizing a schema mapping to map the one or more updated values of the first database schema to corresponding database schema components of the second database schema; and based on the schema mapping and the change log, constructing a write query that uses the second database schema to update the shadow copy of the data record to include the one or more updated values.

In some aspects, the techniques described herein relate to a hybrid database storage system, wherein the control layer transfers the ownership of the data record by marking at least one of the primary copy of the data record and the shadow copy of the data record to indicate that the second database is a current owner of the primary copy of the data record.

In some aspects, the techniques described herein relate to a hybrid database storage system, wherein the control layer is configured to: receiving an update request to update the data record after the ownership of the data record is transferred to the second database; in response to the update request, construct and transmit a read request to at least one of the first database and the second database; based on data received in response to the read request, determine whether the data record exists and whether the data record is owned by the first database or the second database; in response to determining that the data record exists and is owned by the second database, construct and transmit a write query to update the data record in the second database.

In some aspects, the techniques described herein relate to one or more tangible computer-readable storage media storing processor-executable instructions for executing a computer process, the computer process including: receiving a request to write a data record to a hybrid database storage system, the hybrid database storage system including a first database storing data according to a first database schema and a second database storing data according to a second database schema; assigning ownership of the data record to the first database in response to receiving the request; writing a primary copy of the data record to the first database; while the first database remains owner of the data record: detecting changes to the primary copy of the data record made in the first database, the changes including updated values to schema components of the first database schema; accessing a schema mapping to map the updated values to corresponding schema components defined with respect to the second database schema; and based on a schema mapping that schema components of the first database schema to corresponding components of the second database schema, constructing one or more queries executable to propagate the changes to a shadow copy of the data record stored in the second database; in response to determining a set of ownership transfer criteria are satisfied for the data record, transferring ownership of the data record from the first database to the second database; and subsequent to transferring the ownership, directing updates to the data record to the second database.

In some aspects, the techniques described herein relate to one or more tangible computer-readable storage media, wherein the computer process further includes: subsequent to transferring the ownership of the data record from the first database to the second database, evaluating clean-up criteria applicable to the data record; and in response to determining that the clean-up criteria are satisfied for the data record, deleting the data record from the first database.

In some aspects, the techniques described herein relate to one or more tangible computer-readable storage media, wherein the computer process further includes: evaluating one or more characteristics of the data record to identify an ownership transfer policy applicable to the data record from a plurality of ownership transfer policies defined for different data records in the hybrid database storage system, the ownership transfer policy defining the set of ownership transfer criteria for the data record.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method comprising:
receiving, at a hybrid database storage system, a write request for a data record;
in response to receipt of the write request for the data record, assigning ownership of the data record to a first database of the hybrid database storage system;
writing a primary copy of the data record to the first database of the hybrid database storage system;
while the first database retains ownership of the data record, detecting changes to the primary copy of the data record made in the first database and propagating the changes to a shadow copy of the data record to a second database of the hybrid database storage system;
transferring ownership of the data record from the first database to the second database; and
subsequent to transferring ownership, directing updates to the data record to the second database.

2. The method of claim 1, further comprising:
identifying, from a plurality of stored ownership transfer policies, an ownership transfer policy that applies to the data record and that defines one or more ownership transfer criteria; and
transferring the ownership of the data record in response to determining the one or more ownership transfer criteria are satisfied for the data record.

3. The method of claim 1, further comprising:
subsequent to transferring ownership of the data record from the first database to the second database, identifying a clean-up policy applying to the data record from a plurality of clean-up policies stored in association with different data records or data record characteristics, the clean-up policy defining clean-up criteria applicable to the data record; and
in response to determining that the clean-up criteria are satisfied for the data record, implementing the clean-up policy by deleting the data record from the first database.

4. The method of claim 1, further comprising:
in response to receiving the data record at a control layer, identifying, based on one or more characteristics of the data record, at least one of a record creation policy and a redundancy policy applicable to the data record; and
based on at least one of the record creation policy or the redundancy policy:
designating the first database as a primary database to execute access requests targeting the data record; and
designating the second database as a shadow database to store the shadow copy of the data record and update the shadow copy based on change logs documenting updates to the primary copy of the data record in the first database.

5. The method of claim 1, further comprising:
evaluating one or more characteristics of the data record to identify an ownership transfer policy applicable to the data record from a plurality of ownership transfer policies defined for different data records in the hybrid database storage system, the ownership transfer policy defining the ownership transfer criteria for the data record.

6. The method of claim 1, wherein the first database stores data according to a first database schema and the second database stores data according to a second database schema and wherein propagating the changes to the shadow copy of the data record includes:
receiving a change log from the first database, the change log identifying one or more updated values and corresponding database schema components of the first database schema;
utilizing a schema mapping to map the one or more updated values of the first database schema to corresponding database schema components of the second database schema; and
based on the schema mapping, constructing a write query to update the shadow copy of the data record according to the second database schema.

7. The method of claim 1, wherein transferring ownership of the data record includes marking at least one of the primary copy of the data record and the shadow copy of the data record to indicate that the second database is now owner of the primary copy of the data record.

8. The method of claim 1, wherein directing updates to the data record to the second database without updating data in the first database further comprises:
receiving an update request to update the data record;
in response to the update request, constructing and transmitting a read request to at least one of the first database and the second database;
based on data received in response to the read request, determining whether the data record exists and whether the data record is owned by the first database or the second database;
in response to determining that the data record exists and is owned by the second database, constructing and transmitting a write query to update the data record in the second database.

9. The method of claim 1, further comprising:
in response to assigning ownership of the data record to the first database, adding an identifier of the data record to a shadow mode index; and
monitoring changes made to a primary copy of each data record in the shadow mode index;
in response to detecting a change to a primary copy of a select data record identified in the shadow mode index, propagating the change to a corresponding shadow copy of the data record that is stored in a different database than the primary copy.

10. A hybrid database storage system comprising:
a first database;
a second database; and
a control layer that:
receives a request to write a data record;
assigns ownership of the data record to the first database;
instructs the first database to store a primary copy of the data record;
while the first database retains ownership of the data record, detects changes to the primary copy of the data record in the first database and propagates the changes to a shadow copy of the data record in the second database;
transfers the ownership of the data record from the first database to the second database in response to determining one or more ownership transfer criteria are satisfied for the data record; and
while the second database retains ownership of the data record, directs updates to the data record to the second database.

11. The hybrid database storage system of claim 10, wherein the control layer:
identifies and evaluates clean-up criteria applicable to the data record;
in response to determining that the clean-up criteria are satisfied for the data record, deletes the data record from the first database.

12. The hybrid database storage system of claim 11, wherein the clean-up criteria for the data record are defined in a clean-up policy maintained by the hybrid database storage system among a plurality of clean-up policies, and wherein the control layer identifies an applicable one of the plurality of clean-up policies based on characteristics of the data record.

13. The hybrid database storage system of claim 10, wherein the control layer:
based on one or more characteristics of the data record, at least one of a record creation policy and a redundancy policy applicable to the data record; and
based on at least one of the record creation policy and the redundancy policy, designates the first database as a primary database and the second database as a shadow database, wherein the primary database is the owner of the data record.

14. The hybrid database storage system of claim 10, wherein the control layer:
evaluates one or more characteristics of the data record to identify an ownership transfer policy that applies to the data record from a plurality of ownership transfer policies defined for different data records in the hybrid database storage system, the ownership transfer policy defining the one or more ownership transfer criteria for the data record.

15. The hybrid database storage system of claim 10, wherein the first database stores data according to a first database schema and the second database stores data according to a second database schema and wherein the control layer propagates the changes to the shadow copy by performing operations that include:
receiving a change log from the first database, the change log identifying one or more updated values within the data record and corresponding database schema components of the first database schema;
utilizing a schema mapping to map the one or more updated values of the first database schema to corresponding database schema components of the second database schema; and
based on the schema mapping and the change log, constructing a write query that uses the second database schema to update the shadow copy of the data record to include the one or more updated values.

16. The hybrid database storage system of claim 10, wherein the control layer transfers the ownership of the data record by marking at least one of the primary copy of the data record and the shadow copy of the data record to indicate that the second database is a current owner of the primary copy of the data record.

17. The hybrid database storage system of claim 10, wherein the control layer is configured to:
receiving an update request to update the data record after the ownership of the data record is transferred to the second database;
in response to the update request, construct and transmit a read request to at least one of the first database and the second database;
based on data received in response to the read request, determine whether the data record exists and whether the data record is owned by the first database or the second database;
in response to determining that the data record exists and is owned by the second database, construct and transmit a write query to update the data record in the second database.

18. One or more tangible computer-readable storage media storing processor-executable instructions for executing a computer process, the computer process comprising:
receiving a request to write a data record to a hybrid database storage system, the hybrid database storage system including a first database storing data according to a first database schema and a second database storing data according to a second database schema;
assigning ownership of the data record to the first database in response to receiving the request;
writing a primary copy of the data record to the first database;
while the first database remains owner of the data record:
detecting changes to the primary copy of the data record made in the first database, the changes including updated values to schema components of the first database schema;
accessing a schema mapping to map the updated values to corresponding schema components defined with respect to the second database schema; and
based on a schema mapping that schema components of the first database schema to corresponding components of the second database schema, constructing one or more queries executable to propagate the changes to a shadow copy of the data record stored in the second database;
in response to determining a set of ownership transfer criteria are satisfied for the data record, transferring ownership of the data record from the first database to the second database; and
subsequent to transferring the ownership, directing updates to the data record to the second database.

19. The one or more tangible computer-readable storage media of claim 18, wherein the computer process further comprises:
subsequent to transferring the ownership of the data record from the first database to the second database, evaluating clean-up criteria applicable to the data record; and
in response to determining that the clean-up criteria are satisfied for the data record, deleting the data record from the first database.

20. The one or more tangible computer-readable storage media of claim 18, wherein the computer process further comprises:
evaluating one or more characteristics of the data record to identify an ownership transfer policy applicable to the data record from a plurality of ownership transfer policies defined for different data records in the hybrid database storage system, the ownership transfer policy defining the set of ownership transfer criteria for the data record.
